(19) United States
(12) Patent Application Publication
(10) Pub. No.: US 2005/0127331 A1
(43) Pub. Date: Jun. 16, 2005

(54) Synthesis of a water dispersible complex between polypyrrole and poly(acrylic acid)

(76) Inventors: Sze Cheng Yang, Wakefield, RI (US); Patrick McCarthy, Sunnyvale, CA (US)

Correspondence Address: Gauthier & Connors LLP, Suite 3300, 225 Franklin Street, Boston, MA, 02110, US

(21) Appl. No.: 10/994,557

(22) Filed: Nov. 22, 2004

Related U.S. Application Data
(63) Continuation of application No. 09/825,460, filed on Apr. 3, 2001, now abandoned.
(60) Provisional application No. 60/194,297, filed on Apr. 3, 2000.

(51) Int. Cl. H01C 1/00

(52) U.S. Cl. 252/500

(57) ABSTRACT

A molecular complex which includes a template having a plurality of ionic functional groups and a conducting polymer. The conducting polymer may be polypyrrole, polythiophene or poly(phenylene sulfide) and substituted versions thereof. The conducting polymer has charges on it which bind to the organic functional group. The complex has a polypyrrole ration of between about 0.5 to 4.5.

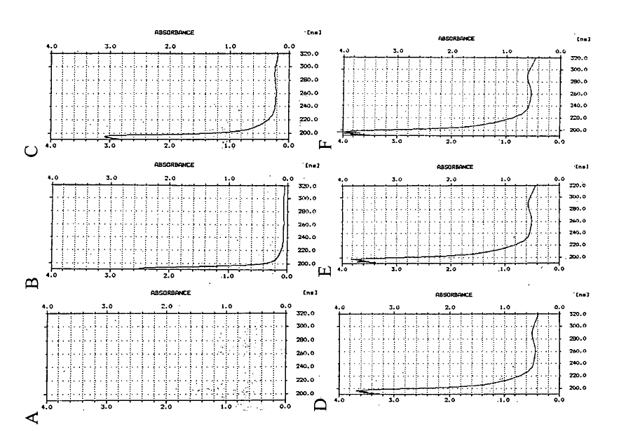

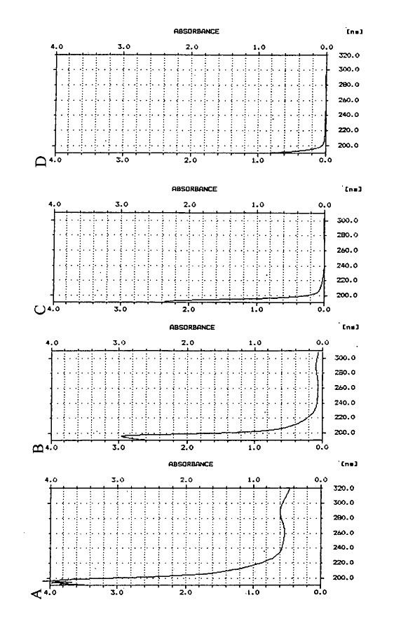

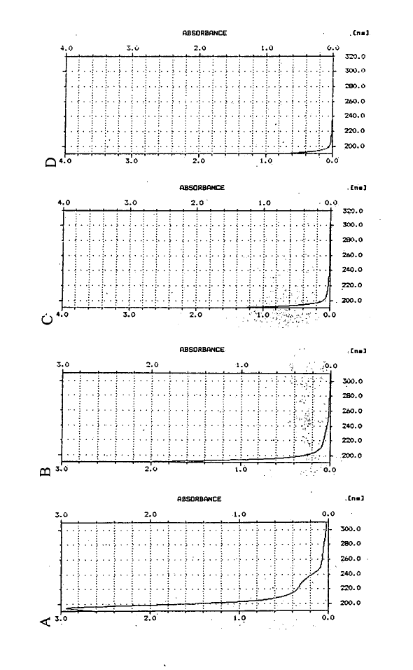

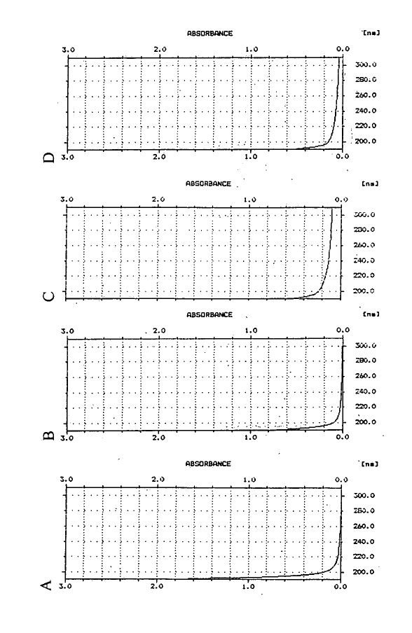

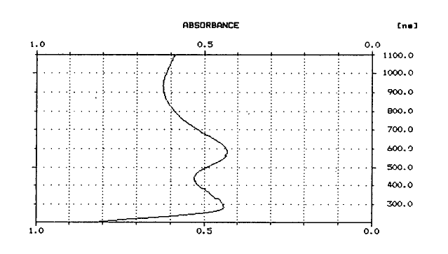

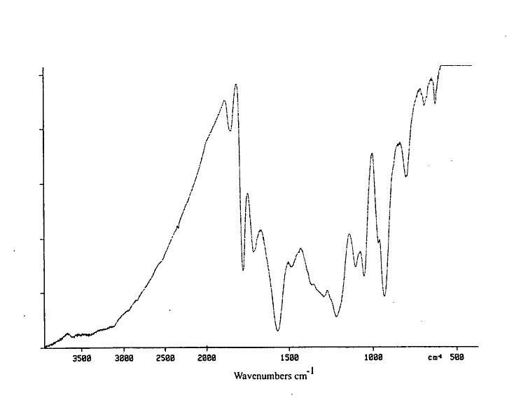

### BACKGROUND OF THE INVENTION

1. Field of the Invention

Molecular complexes containing a conductive polymer(s).

2. Description of the Relevant Art

Template polymerization was first observed in biological systems as DNA self-replication and protein biosynthesis. One DNA strand (the parent strand) acts as a template for the biosynthesis of a second DNA strand (the daughter strand). Template polymerization was first utilized in a chemical synthesis, circa 1956. Since 1956, template polymerization has been employed in the synthesis of many molecular complexes.

Organic polymers that conduct electricity have been discovered relatively recently. Polymers of this class have been proposed as materials for applications including anti-static coatings, anti-corrosive paints, etc. Conducting polymers, however, are notorious for being intractable. There has been tremendous effort to render them soluble or dispersible in common solvents while maintaining a high level of electrical conductivity. The most common methods include functionalizing the conducting polymer, using small molecule surfactants.

One method found successful for making molecular complexes with conducting polymers is template guided polymerization of the conductive monomer.

A discussion of the general method of this chemical synthesis can be found in U.S. Pat. No. 5,489,400 (Sze Yang) and other patents and publications of Sze Yang.

Of the many conductive polymers have been identified, polyaniline is the most widely investigated. Although polypyrrole is commonly mentioned it has not been a monomer of choice because it was generally considered difficult to work with. Aniline has certain drawbacks notably carcinogenic by-products and synthesis in high acid conditions.

### BRIEF SUMMARY OF THE INVENTION

The molecular complexes embodying the invention can be used as a protective coating, as an adhesive material, as an anti-electrostatic material, in chemical separation applications, e.g. stationary phase for purifying materials, and for film in rechargeable batteries.

It has been discovered that polypyrrole complexes can be synthesized with polyelectrolytes without the concern of carcinogenic bioproducts which is not the case with polyaniline. The manufacturing process for the polypyrrole is done in a less acidic reaction medium, e.g. pH 2 to 7, than that required for polyaniline, e.g. pH −1 to 1. It is easier to synthesize polypyrrole complexes as water borne products. Conditions for synthesis are less stringent specifically less acid is needed for polymerization. The scope of materials that can be used for synthesis is broader than prior art techniques, specifically polymers that precipitate out under acidic conditions can be used as the template in the template-guided synthesis.

There is more flexibility in choosing the second strand or the polymeric dopant for the conducting polymer because the reaction medium is less acidic than required for polyanilines. The conducting polymeric complexes are water borne and solvent dispersible and more stable than prior art molecular complexes.

It is believed possible to synthesize conducting complexes with new optical properties using chiral polymers as a template for the template-guided synthesis of the conducting polymer complex.

The invention broadly comprises a water dispersible molecular complex between a polyelectrolyte and an electrically conductive polymer. The polyelectrolyte can be selected from the group consisting of poly(styrene sulfonic acid), poly(acrylic acid), poly(vinyl methyl ether-co-maleic acid), poly(methacrylate acid), poly(2-acryamido-2-methyl-1-propene sulfonic) acid, poly(butadiene-maleic acid), poly(phenylene vinylene) and salts and co-polymers thereof while the conducting polymer can be selected from the group consisting of polypyrrole, polythiophene or poly(phenylene sulfide) and substituted versions thereof.

There are two components of the complex: Strand 1 is a conducting polymer, polypyrrole. Strand 2 is a polyelectrolyte. The two polymer strands are bonded non-covalently by electrostatic interactions, hydrogen bonding, and van der Waals forces. The ideal structure of the complex consists of the two polymer strands side-by-side and in intimate contact. The actual structure is likely to be less ordered.

The template guided synthesis is carried out step-wise. First, monomers are added to a dilute solution of polyelectrolyte. Second, the monomers are polymerized into polymers and the molecular complex is formed.

In a preferred embodiment, the conducting polymer comprises polypyrrole (PPy) and poly(acrylic acid) (PAA or polypyrrole (PPy) and poly(vinylmethylether-co-maleic acid) (PVMEMA).

### DESCRIPTION OF THE PREFERRED EMBODIMENT(S)

The invention will be described with reference to the following non-limiting examples.

### EXAMPLE I

### polypyrrole/polyacrylic Acid

Step one. An adduct is formed by adding pyrrole monomer to a dilute solution of polyelectrolyte. Over time the pyrrole adsorbs onto the backbone of the polyelectrolyte through hydrogen bonding, van der Waals, and/or other short range forces. Once bound to the polyelectrolyte the pyrrole is arranged linearly. Therefore, the adduct is a self-assembled, non-covalent structure that resembles the structure of the targeted molecular complex. The adduct is (Py)ₓ:PAA where (Py)ₓ represents a certain number of pyrrole monomers bound to poly (acrylic acid).

(Py)ₓ:PAA Adduct Formation

Formation of the adduct between pyrrole and poly (acrylic acid) is described as follows: Dilute 7.0 grams 25% w/w poly(acrylic acid) (90,000MW, Polysciences) (0.024 mole carboxylic acid group) to 50 mL with distilled water. Stir for 2 hours. Add 0.85 ml pyrolle (Aldrich, 0.014 mole). Stir for 24 hours.

Step Two:

Polymerization of the Adduct

In step two, the pyrrole is polymerized to polypyrrole by adding an oxidant. The oxidant oxidized pyrrole to its radical form. Two pyrroles in their radical forms can combine to form a dimer by eliminating two protons. The dimer or higher oligomer can be further oxidized and therefore the reaction can proceed to high molecular weight polypyrrole. The adduct resembles the molecular complex, that is, pyrrole is more concentrated around poly(acrylic acid) than in the bulk solution. Once pyrrole is polymerized to polypyrrole, very little rearrangement needs to take place for the forming molecular complex to adopt a side-by-side orientation. The molecular complex is identified with the symbol PPy:PAA.

Polymerization of the Adduct to the Molecular Complex

In step 3 of the synthesis, the adsorbed polypyrrole in the adduct (Py)ₓ:PAA is polymerized to form the molecular complex PPy:PAA. Add 6.08 ml 2 M sodium persulfate (Aldrich, 0.014 mole). Stir for 24 hours.

### EXAMPLE II

(Py)ₓ:PVMEMA Adduct Formation:

Formation of the adduct between pyrrole monomer and poly(vinylmethylether-co-maleic acid). Dissolve 0.25 grams of poly(vinylmethylether-co-maleic anhydride)(aldrich, 67,000MW, powder) to 50 ml with distilled water. To promote hydrolysis of the anhydride to the diacid heat the solution to 75° C., cool to room temperature, and continue to stir for 4 hours. Add 0.090 ml pyrrole (Aldrich, 0.0013 mole) and stir for 30 minutes. To promote the self assembly heat to 45° C. and cool to room temperature.

Once this process is complete, the adduct has been formed. (Py)ₓ:PVMEMA to represent the adduct between pyrrole(Py) and poly(vinylmethylether-co-maleic acid) (PVMEMA).

Step Two:

Polymerization of the (Py)ₓ:PVMEMA Adduct

Polymerization of the adduct to form the molecular complex. Add 0.65 ml 2M sodium persulfate (0.0013 mole) to the previously prepared adduct solution. React and stir for 24 hours.

The solution immediately turns dark green and warms up due to the exothermic nature of the polymerization.

Template Guided Synthesis Vs Single Strand Polypyrrole Synthesis

Molecular complexes were synthesized as described above.

Single strand polypyrrole was also synthesized with the same procedure described above in except the polyelectrolytes were omitted from the synthesis.

For the single strand polypyrrole synthesis. Dilute 0.85 mL pyrrole (Aldrich, 0.012 mole) to 50 mL with distilled water. Stir for 24 hours. Add 6.08 ml 2M sodium persulfate (Aldrich, 0.012 mole). Stir for 24 hours.

The products resulting from the single strand polypyrrole synthesis and the molecular complex synthesis have different solubility properties. The single strand polypyrrole precipitates into an intractable solid immediately after initiation of the polymerization. The product resulting from the molecular complex synthesis remains dispersed in common solvents such as distilled water, acidified water, methanol, THF (spell out) or NMP (spell out) for more than six months. The molecular complex is referred to as being water dispersible rather than water soluble because when it is dried as a powder it cannot be redispersed in any solvent.

The conductivity of the single strand polypyrrole and the PVMEMA, and the molecular complex, from the above synthesis were tested as follows:

Single Strand Conductivity Test:

Filter the single strand polypyrrole precipitate product. Wash the product with 0.1 M HCl. Dry the solid in an oven at 140° C. for 24 hours. Grind the solid into a fine powder using a mortar and pestle. Press the powder into a pellet. Measure the conductivity with a four point probe.

PVMEMA Conductivity Test:

Obtain PVMEMA powder from Aldrich. Press the powder into a pellet. Measure the conductivity with a four point probe.

Molecular complex Conductivity Test:

Dry the molecular complex solution at 140° C. in an oven overnight. Grind the solid into a fine powder with a mortar and pestle. Press the powder into a pellet. Measure the conductivity with a four point probe. This test is well known to those skilled in the art (L. J. Van der Pauw, Philips Research Reports, 16, 187 (1961).

The conductivity of the single strand polypyrrole pellet was measured to be 50 S cm⁻¹. The conductivity of the dried PVMEMA powder, an insulator, was measured to be less than 10⁻¹⁰ S cm⁻¹. The conductivity of the molecular complex pellet was measured to be 0.1 to 1 S cm⁻¹.

The molecular complex synthesis product has solubility properties common to both single strand polymers. Single strand polypyrrole is an intractable solid, PVMEMA is soluble in water, and the molecular complex containing the two polymers is dispersible in water.

The molecular complex synthesis product also has conductivity properties common to both single strand polymers. Single strand polypyrrole is electrically conductive, PVMEMA is an insulator, and the molecular complex containing the two polymers has a conductivity that is between that of the two polymers.

Previously synthesized molecular complexes containing conducting polymers also exhibit physical properties that are collective of the physical properties of the two individual strands. In all cases, it is thought that the polyelectrolyte strand is the vehicle for solubility and the conducting polymer is the vehicle for conductivity.

In the previous section was described an molecular complex that has a conductivity much lower than the single strand polypyrrole. Most applications rely on the material to be highly conductive. A water dispersible molecular complex was synthesized with a higher electrical conductivity.

Since polypyrrole is the vehicle for electrical conductivity and PVMEMA is the vehicle for solubility it is thought that the conductivity of the molecular complex can be increased by increasing its polypyrrole concentration. However, molecular complex syntheses are known to result in precipitate products when the concentration of the conducting polymer is increased above some critical value.

It is thought that the ionizable functional groups of the polyelectrolyte are responsible for the solubility properties of the molecular complex. Because of this, we will refer to the number of pyrrole monomers in solution relative to the number of ionizable groups of the polyelectrolyte are referred to as the polypyrrole ratio.

The term “polypyrrole ratio” refers to the number of pyrrole monomers per carboxylic acid group of Strand 2 (PVMEMA) at the adduct stage of the reaction. The pyrrole ratio is calculated by dividing the total number of moles pyrrole by the total number of carboxylic acid groups in Strand 2. The polypyrrole ratio is given below:

$$r = \frac{number of moles pyrrole monomer}{number of moles carboxylic acid group}$$

Assuming that the hydrolysis of poly(vinylmethylether-co-maleic anhydride) to poly(vinylmethylether-co-maleic acid) was complete then, the complex synthesized previously has an r value of 0.5. That is, for every one carboxylic acid group there is 0.5 pyrrole monomers.

The r-value is referred to as the polypyrrole ratio rather than the pyrrole ratio because of the ease in calculation of the number pyrrole monomers in the solution. Previous experimental results show that the number of pyrrole monomers added to the solution during the adduct stage is roughly equal to the number of pyrrole monomers present as polypyrrole within the molecular complex.

### EXAMPLE III

In this experiment, how much pyrrole can be added during the adduct step (Step 1) of the synthetic scheme while maintaining the water-dispersibilty of the molecular complex product is determined. The experiment was carried out by performing five polymeric complex syntheses with increasing polypyrrole ratios.

Synthesis of Molecular complexes with Increasing Polypyrrole Ratios:

Step One: Adduct Formation

Dissolve 0.25 grams of the poly(vinylmethylether-co-maleic anhydride) powder (0.0027 moles carboxylic acid group) in 50 ml distilled water. Heat the solution to 75° C. slowly, cool to room temperature, and stir for 4 hours.

Add “X” grams of pyrolle (see table 1). Stir for 30 minutes, heat to 45° C., and cool to room temperature.

Step Two: Polymerization

Add the quantity of 2M sodium persulfate necessary so that the number of moles sodium persulfate is equal to the number of moles pyrrole monomer. React overnight.

| Synthesis | PVMEMA | Pyrrole “X” | Gram % | |
|---|---|---|---|---|
| # | (grams/moles) | (grams/moles) | PPy/PPy Ratio | Result |
| 1 | 0.25/0.0027 | 0.09/0.0013 | 26%/0.5:1 | D |
| 2 | 0.25/0.0027 | 0.26/0.0039 | 51%/1.5:1 | D |
| 3 | 0.25/0.0027 | 0.52/0.0078 | 68%/3:1 | D |
| 4 | 0.25/0.0027 | 0.78/0.0116 | 76%/4.5:1 | D |
| 5 | 0.25/0.0027 | 1.05/0.0156 | 81%/6:1 | P |

Table 1: This table shows the result of five separate syntheses. The water-dispersiblity of the resulting product is represented by a “D” for dispersible and a “P” for precipitate. Each synthesis was carried out with the same synthetic scheme, reaction conditions, and Strand 2 concentration. The syntheses differed only in the amount of pyrrole and oxidant added. Each synthesis was run with a greater pyrrole concentration and thus a greater r-value.

Polypyrrole gram percentage is estimated by dividing the gram weight of pyrrole added by the sum of the gram weight from the PVMEMA and pyrrole. The gram weight can be calculated by:

$$Gram \% PPy = \frac{grams pyrrole}{( grams pyrrole + grams PVMEMA )}$$

The gram % of the water-dispersible molecular complexes are 24%, 51%, 68%, and 76%. The molecular complex synthesis carried out with a gram percent equal to 81% resulted in a precipitate product.

The five molecular complex syntheses were run at the polypyrrole ratios; r=0.5, 1.5, 3.0, 4.5 and 6.0. When the polypyrrole ratio is between 0.5 and 4.5 the polymeric complex product remains dispersible (“D”) for months. When the reaction is run with a polypyrrole ratio of 6 the reaction product precipitates (“P”) almost immediately. The precipitate cannot be redispersed in acidic, basic or neutral water or methanol.

A polyelectrolyte needs a certain number of functional groups to keep it in solution. PVMEMA has a high solubility in water, e.g. it has an excess number of functional groups necessary to render it water soluble. These excess carboxylic acid groups are believed to be responsible for rendering the molecular complex dispersible in water. The limit for PVMEMA is approximately 4.5 pyrrole units for each carboxylic acid functional group.

A water dispersible molecular complex with four and a half pyrrole units (Strand 1) for every carboxylic functional group in PVMEMA (Strand 2) has been synthesized. This result is somewhat surprising. It is difficult to imagine a simple double-stranded structure for an molecular complex of this polypyrrole ratio.

The conductivities of the five synthesis products were tested by the four point method (described previously). Table 1 shows conductivity vs. weight percent polypyrrole for water-dispersible reaction products and pure polypyrrole.

The conductivity of the five samples is measured across a distance of one centimeter. In this case, the charge carrier (assumed to be a bipolaron for polypyrrole) must propagate from one electrode, through the sample, to the other electrode. If we assume that the length of the polypyrrole strands are on the average as long as strand 2 then the length of the polypyrrole is on a nanometer scale. In order for a sample containing polypyrrole to show conductivity over one centimeter, the charge must be transferred from one polypyrrole chain to the next many times. We refer to this type of charge carrier propagation as interpolymer charge transfer. For interpolymer transfer to occur, the two polypyrrole strands must be very close. The further away from each other the strands are the less likely an interpolymer charge transfer is to occur.

Polypyrrole has a high cohesive energy. In a sample of single strand polypyrrole each polymer is likely to be to close proximity to another polypyrrole strand. This kind of arrangement increases the chances for interpolymer charge transfer. Thus, we observe a high conductivity over a sample of single strand polypyrrole.

The molecular complex has a lower conductivity than the single strand polypyrrole. The molecular complex contains PVMEMA which is an insulator. The lower conductivity in the molecular complex is thought to be due to PVMEMA disrupting the interpolymer charge transfer between two polypyrrole strands. As the weight percent of polypyrrole increases, the chance of PVMEMA insulating the interpolymer charge transfer decreases. The conductivity of the molecular complex approaches that of single strand polypyrrole.

There seems to be a fine balance between controlling the solubility properties of the molecular complex and maximizing its conductivity. PVMEMA enables the molecular complex to be dispersible in water but it also lowers its conductivity.

Purification

As with most syntheses the molecular complex synthesis results in a mixture of the desired product and undesirable byproducts. The impurities may include: unreacted pyrrole monomers, pyrrole dimer, trimer, other low degree of polymerization polypyrrole, sodium persulfate degradation products, and other oxidation byproducts. The molecular complex was characterized by UV/VIS, IR and it was purified by well known dialysis techniques.

The interpolymer product was purified exhaustively by 0.1MHCl, methanol and distilled water.

A UV/VIS spectrum taken of the PAA:PP complex product diluted in distilled water was consistent with UV/VIS spectra of polypyrrole in the literature. Two absorpotion bands were observed at 440 nm and 940 nm.

An IR spectrum of the polymeric complex was taken via the KBr method. The spectra shows bands characteristic of both polypyrrole and poly(acrylic acid). The position and pattern of peaks are consistent with IR spectra of polypyrrole in the literature. The strong band at 1555 cm⁻¹ has been assigned to the skeletal stretching of the pyrrole ring.

The bands at 1707 cm⁻¹ and 1450 cm⁻¹ are characteristic of poly (acrylic acid)[1,2]. The band at 1707 cm⁻¹ arises from carbonyl stretching. The band at 1450 cm⁻¹ arises from CH₂ deformation. The asymmetric stretching mode of the CO₂— group expected at 1550 cm⁻¹ is obscured by the skeletal stretching band from the polypyrrole. The IR spectrum suggests the presence of both poly (acrylic acid) and polypyrrole in the product.

A UV/VIS spectrum was taken of the PVMEcoMA:PP complex product diluted in distilled water. The UV/VIS spectrum is consistent with UV/VIS spectra of polypyrrole in the literature. Two absorption bands were observed at 440 nm and 940 nm.

An IR spectrum of the polymeric complex was taken via the KBr method.

The spectra showed bands within the fingerprint region that are characteristic of polypyrrole. The position and pattern of peaks are consistent with IR spectra of polypyrrole in the literature. The strong band at 1555 cm⁻¹ has been assigned to the skeletal stretching of the pyrrole ring.

The spectra also shows bands that are characteristic of PVMEMA. The position and pattern of peaks are consistent with IR spectra of PVMEMA in the literature.

Poly(vinylmethylether-co-maleic anhydride) can exist as the acid or the anhydride form. The maleic acid form can be converted to the maleic anhydride form by dehydration.

The band at 1714 cm⁻¹ is corresponds to the stretching of the carbonyl in the maleic acid form. The asymmetric stretching mode of the CO₂— group expected at 1550 cm⁻¹ is obscured by the skeletal stretching band from the polypyrrole. The bands at 1777 cm⁻¹ and 1855 cm⁻¹ correspond to the anhydride carbonyl.

IR bands that correspond to the maleic anhydride and the maleic acid form of the polyelectrolyte are present in the IR spectra of the polymeric complex.

The IR spectrum suggests the presence of both poly(vinylmethylether-co-maleic anhydride) and polypyrrole in the product.

The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

1. A molecular complex which comprises:
a template having a plurality of ionic functional groups; and
a conducting polymer selected from the group consisting of polypyrrole, polythiophene or poly(phenylene sulfide) and substituted versions thereof having charges thereon which bind to the organic functional group, the complex having a polypyrrole ratio of between about 0.5 to 4.5.

2. The complex of claim 1 wherein the template is selected from the group consisting essentially of chiral polymers and polyelectrolytes.

3. The complex of claim 2 wherein the polyelectrolytes are selected from the group consisting essentially of poly(styrene sulfonic acid), poly(acrylic acid), poly(vinyl methyl ether-co-maleic acid), poly(methacrylate acid), poly(2-acryamido-2-methyl-1-propene sulfonic) acid, poly(butadiene-maleic acid), poly(phenylene vinylene) and salts and co-polymers thereof.

4. The molecular complex of claim 1 wherein the conducting polymer is selected from the group consisting essentially of poly(acrylic acid) or poly(vinyl methyl ether-co-maleic acid, and the conducting polymer is polypyrrole.

5. A method for the formation of a molecular complex comprising a template having a plurality of ionic functional groups and a conducting polymer having charges thereon which comprises:
forming a monomer template adduct in a pH range of between about 2 to 7; and
polymerizing the monomer to form the conducting polymer, the conducting polymer ratio being between about 0.5 to 4.5.

6. The complex of claim 5 wherein the template is selected from the group consisting essentially of chiral polymers and polyelectrolytes.

7. The complex of claim 6 wherein the polyelectrolytes are selected from the group consisting essentially of poly(styrene sulfonic acid), poly(acrylic acid), poly(vinyl methyl ether-co-maleic acid), poly(methacrylate acid), poly(2-acryamido-2-methyl-1-propene sulfonic) acid, poly(butadiene-maleic acid), poly(phenylene vinylene) and salts and co-polymers thereof.

8. The molecular complex of claim 5 wherein the conducting polymer is selected from the group consisting essentially of poly(acrylic acid) or poly(vinyl methyl ether-co-maleic acid, and the conducting polymer is polypyrrole.
